(19) United States
(12) Patent Application Publication
(10) Pub. No.: US 2017/0346150 A1
(43) Pub. Date: Nov. 30, 2017

(54) Modified Radio Frequency (RF) Combiner

(71) Applicant: SIEMENS RESEARCH CENTER LIMITED LIABILITY COMPANY, Moscow (RU)

(72) Inventors: Alexander Yourievich SMIRNOV, Moscow (RU); Andrey Aleksandrovich KRASNOV, Moscow (RU)

(73) Assignee: SIEMENS RESEARCH CENTER LIMITED LIABILITY COMPANY, Moscow (RU)

(21) Appl. No.: 15/532,809

(22) PCT Filed: Dec. 5, 2014
(86) PCT No.: PCT/RU2014/000913

§ 371 Date: Jun. 2, 2017

(51) Int. Cl. H01P 5/12

(52) U.S. Cl. CPC H01P 5/12

(57) ABSTRACT

A modified radio frequency (RF) power combiner that includes a matching circuit, a plurality of first RF ports, exactly one second RF port and a casing, wherein the matching circuit is arranged inside the casing, and the plurality of first RF ports and the second RF port are arranged at a first side of the casing.

### CROSS-REFERENCE TO RELATED APPLICATIONS

This is a U.S. national stage of application No. PCT/RU2014/000913filed 5 Dec. 2014.

### 1. FIELD OF THE INVENTION

The present invention relates to RF power combiners or RF power splitters.

### 2. DESCRIPTION OF THE RELATED ART

RF power combiners are devices used in radio technology when there is a requirement to combine radio frequency (RF) power or RF signals. RF power combiners receive a plurality of RF inputs and transform the impedance of the received RF inputs to an impedance of a single output. RF power splitters, also known as RF power dividers, are devices used in radio technology when there is a requirement to split RF power or RF signals. RF power splitters receive a single RF input and transform the impedance of the received RF input to an impedance of a plurality of RF outputs. Thus, RF power combiners and RF splitters are basically the same RF device and include a matching circuit. The matching circuit can be used to combine or to split RF power, the only difference being that RF power is applied to one port and extracted from others in the case of the RF splitter, and for the RF combiner, RF power is applied in the opposite direction.

The RF power combiners or the RF power splitters in the present disclosure mean one and the same thing which has been hereinafter referred to as the RF power combiner. The RF power combiner known in the art of radio technology have linear orientation thereby placing the RF power input and RF power output in a linear alignment on different sides of the RF power combiner. When such a conventional RF power combiner is used in an assembly of a RF tract and placed in a standardized modular system, such as a 19-inch rack, a requirement to have the RF connectors transmitting the RF output or the RF input at the same side of such a standardized module is generated. In order to fulfill this requirement, additional waveguide bends are used, such as E-bends or H-bends if the RF system is based on a rectangular waveguide architecture, or coaxial ‘elbows’ if the RF system operates with coaxial lines. This results in bigger overall dimensions and higher costs of the RF system because the assembly of such an RF system or RF tract involves multiple components, i.e., at least the power combiner and the additional waveguide bends.

Moreover, in most cases, physical contacts, such as waveguide flanges, are also required to establish and maintain the connection between the additional waveguide bends and the RF output or the RF input in the RF tract. The physical contacts need to be protected against disruption or dislocation to ensure proper functioning of the RF power combiner, and thus to ensure the performance of the entire RF system is not jeopardized. Moreover, assembling such a RF tract or RF system with multiple RF devices, i.e., the conventional RF power combiner, additional waveguide bends, or waveguide flanges, is complex and cumbersome and, thus, requires expertise and experience.

### SUMMARY OF THE INVENTION

In view of the foregoing, it is therefore an object of the present invention to provide a modified RF combiner that is compact, easy to integrate into a RF tract, and that at least partially obviates possibilities of disruption of connection between the additional waveguide bends and the RF output or the RF input of the RF power combiner in the RF tract.

These and other objects and advantages are achieved in accordance with the invention by a modified RF power combiner that includes a matching circuit, a plurality of first RF ports, exactly one second RF port and a casing. The matching circuit is arranged inside the casing. The plurality of first RF ports and the single second RF port are arranged at a first side of the casing. In the modified RF power combiner, the second RF port is connected in series with the matching circuit and each of the plurality of the first RF ports. As a result, the modified RF power combiner is compact when introduced in an RF tract or an RF system or any standardized module because the requirement to have additional waveguide bends is at least partially reduced. Moreover, the requirements of additional waveguide bends and physical contacts, such as waveguide flanges, is obviated. As a result, disruption of the connection between the additional waveguide bends and the RF output or the RF input of the RF power combiner in the RF tract is obviated. Furthermore, integration of the modified RF power combiner into a RF tract or standardized module is easier and hassle free.

In an embodiment of the modified RF power combiner, each of the first RF ports is connected via an inner conductor to the matching circuit. This ensures that RF power can be conveniently provided to the matching circuit arranged inside the casing through the first RF ports when the modified RF power combiner is functioning to combine RF power and without requiring disassembly of or opening of the casing. Alternatively, this also ensures that RF power can be conveniently received from the matching circuit arranged inside the casing through the first RF ports when the modified RF power combiner is functioning to split RF power and without requiring disassembly or opening of the casing. Here, the first RF ports are connected to the matching circuit in parallel.

In another embodiment of the modified RF power combiner, each of the inner conductors is arranged inside the casing. The casing thus protects the inner conductors and further ensures that any possibility of disruption of connection between the first RF ports and the matching circuit, when the modified RF power combiner is being integrated into a RF tract or is being stored or transported or while in operation as part of a RF tract, is at least partially obviated.

In another embodiment of the modified RF power combiner, the second RF port is connected via a single transmission line to the matching circuit. This ensures that RF power can be conveniently received from the matching circuit arranged inside the casing through the second RF port when the modified RF power combiner is functioning to combine RF power and without requiring disassembly or opening of the casing. Alternatively, this also ensures that RF power can be conveniently provided to the matching circuit arranged inside the casing through the second RF port when the modified RF power combiner is functioning to split RF power and without requiring disassembly of or opening of the casing.

In another embodiment of the modified RF power combiner, the single transmission line is arranged inside the casing. The casing thus protects the single transmission line and further ensures that any possibility of disruption of the connection between the second RF port and the matching circuit, when the modified RF power combiner is being integrated into a RF tract or being stored or transported or while in operation as part of a RF tract, is at least partially obviated.

In another embodiment of the modified RF power combiner, the single transmission line forms a 180 degree turn between the matching circuit and the second RF port. This provides a simple way of arranging the matching circuit and the single transmission line within the casing and relative to the second RF port.

In another embodiment of the modified RF power combiner, the casing has a cuboidal shape. The first side of the casing forms one face of the cuboid. Such a casing is easy to fabricate and can be fabricated in a size that is compatible with standardized frames or enclosures for mounting multiple equipment modules.

In another embodiment of the modified RF power combiner, the casing is configured to mount inside a 19-inch rack. Such 19-inch racks or 19-inch cabinets are used in various RF tracts or systems and, thus, the modified RF power combiner is physically compatible to be integrated in such RF tracts or systems.

In another embodiment of the modified RF power combiner, the casing includes a mount for mounting the modified RF power combiner inside a 19-inch rack. Thus, the requirement for an additional way to mount or for complicated contraptions for mounting the modified RF power combiner inside a 19-inch rack is at least partially obviated.

In another embodiment of the modified RF power combiner, the mounting means is a slide, where the modified RF power combiner is mountable inside a 19-inch rack by slidingly engaging the slide with rails of the 19-inch rack. This at least partially obviates the requirement to attach and/or detach the modified RF power combiner and the 19-inch rack. Moreover, the modified RF power combiner can be easily dismounted from the 19-inch rack, which may be required for inspection or maintenance of the modified RF power combiner or the 19-inch rack or any other components mounted on the 19-inch rack.

In another embodiment of the modified RF power combiner, the mount is a fastner for fixedly mounting the modified RF power combiner inside a 19-inch rack. Thus, when mounted inside the 19-inch rack the modified RF power combiner stays in place and does not dislocate due to physical disturbances of the 19-inch rack or the surroundings.

In another embodiment of the modified RF power combiner, the plurality of the first ports and the second port are embedded in a wall of the casing on the first side of the casing. Thus, the additional requirement to affix the first ports and the second port on the first side of the casing are at least partially obviated.

In another embodiment of the modified RF power combiner, the wall of the casing, along with the plurality of the first ports and the second port embedded in the wall, completely encloses a volume. The matching circuit is positioned in the volume. The matching circuit and its connections to the first and the second ports are thus protected from external disturbances.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein. The present technique is further described hereinafter with reference to illustrated embodiments shown in the accompanying drawing, in which:

The FIGURE illustrates a modified RF power combiner 1 for RF power combining or RF power splitting, in accordance with embodiments of the present invention.

### DETAILED DESCRIPTION OF THE EXEMPLARY EMBODIMENTS

Hereinafter, above-mentioned and other features of the present technique are described in details. Various embodiments are described with reference to the drawing, wherein like reference numerals are used to refer to like elements throughout. In the following description, for purpose of explanation, numerous specific details are set forth in order to provide a thorough understanding of one or more embodiments. It may be noted that the illustrated embodiments are intended to explain, and not to limit the invention. It may be evident that such embodiments may be practiced without these specific details.

Shown in the FIGURE is a modified RF power combiner 1 for RF power combining or RF power splitting in accordance with the present invention. The modified RF power combiner 1 is also a modified RF power splitter. However, for the sake of simplicity in the present disclosure only the term ‘modified RF power combiner’ has been used for both RF power combining or RF power splitting functions. The modified RF power combiner 1 includes a matching circuit 3, a plurality of first RF ports 4, exactly one second RF port 7 and a casing 2. The matching circuit 3 is arranged inside the casing 2. The plurality of first RF ports 4 and the second RF port 7 are arranged at a first side 21 of the casing 2.

The first RF ports 4 are functionally distinct from the second RF port 7, i.e., when the modified RF power combiner 1 is used to combine RF power or RF signal the first RF ports 4 act as an input for an RF signal into the modified RF power combiner 1 and the second RF port 7 acts as an output for an RF signal emanating from the modified RF power combiner 1. Similarly, when the modified RF power combiner 1 is used to split or divide the RF power or RF signal the second RF port 7 acts as the input for RF signal into the modified RF power combiner 1 and the first RF ports 4 acts as the output for the RF signal emanating from the modified RF power combiner 1.

When the modified RF power combiner 1 is used to combine RF power or RF signal, the matching circuit 3 is an RF power combining circuit that accepts multiple input RF signals and delivers a single RF output signal. The matching circuit 3 is connected to the first RF ports 4. The matching circuit 3 receives RF power from two or more of the plurality of the first RF ports 4 via inner conductors 5 of the first RF ports 4 and transforms the impedance of the received RF power to an impedance of a resultant single output. The resultant single output exits the matching circuit 3 via a single transmission line 6. The matching circuit 3 may be of various types, such as zero-degree RF power combiners, and may have any technical specification. The structure and operation of such matching circuits 3 are well known in art of radio technology, particularly in RF combiners, and thus has not been described in details herein for the sake of brevity.

Alternatively, when the modified RF power combiner 1 is used to split an RF power or RF signal, the matching circuit 3 is a RF power splitting circuit that accepts a single input RF signal and delivers multiple RF output signals. The matching circuit 3 is connected to the second RF port 7 via the single transmission line 6. The matching circuit 3 receives RF power from the second RF port 7 via the single transmission line 6 and transforms the impedance of the received RF power to an impedance of resultant multiple outputs. The resultant multiple outputs exit the matching circuit 3 via the inner conductors 5 and, finally, through the plurality of the first RF ports 4. The matching circuit 3 may be of various types, and may have any technical specification. The structure and operation of such matching circuits 3 are well known in art of radio technology, particularly in RF splitters, and thus has not been described in details herein for the sake of brevity.

It should be noted that in the present disclosure the term ‘connected’ or similar phrases means linked by a transmission means such that RF power can transmit via the transmission means. Thus when a first entity is said to be connected to a second entity, then the first entity is linked to the second entity via a transmission means, e.g., a RF conductor or a wave guide such that RF power can transmit between the first and the second entity via the transmission means. To explain further, the matching circuit 3 is connected to the first RF ports 4 means the matching circuit 3 is linked to the first RF ports 4 via a transmission means, in this case the inner conductors 5, such that RF power or RF signal is transmittable between the matching circuit 3 and the first RF ports 4. Thus, when an RF signal is received or applied at the first RF ports 4, the received or applied RF signal from the first RF ports 4 is transmitted to the matching circuit 3 via the inner conductors 5. Furthermore, when a RF signal exits or emanates from the matching circuit 3 in a direction towards the inner conductors 5, the emanating RF signal from the matching circuit 3 is transmitted to the first RF ports 4 via the inner conductors 5.

Similarly, the matching circuit 3 is connected to the second RF port 7 means the matching circuit 3 is linked to the second RF port 7 via a transmission means, in this case the single transmission line 6, such that RF power or RF signal is transmittable between the matching circuit 3 and the second RF port 7. Thus, when a RF signal is received or applied at the second RF port 7, the received or applied RF signal from the second RF port 7 is transmitted to the matching circuit 3 via the single transmission line 6. Furthermore, when an RF signal exits or emanates from the matching circuit 3 in a direction towards the single transmission line 6, the emanating RF signal from the matching circuit 3 is transmitted to the second RF port 7 via the single transmission line 6.

In the modified RF power combiner 1, the casing 2 encases, encloses or houses the matching circuit 3 and the connections between the matching circuit 3 and the first RF ports 4 and the second RF port 7. The plurality of the first RF ports 4 and the second RF port 7 are arranged or located at the first side 21 of the casing 2. In one embodiment of the modified RF power combiner 1, the single transmission line 6 forms a 180 degree turn between the matching circuit 3 and the second RF port 7, thus enabling the positioning of the first RF ports 4 and the second RF port 7 on the same side of the casing 2, i.e., on the first side 21 of the casing 2.

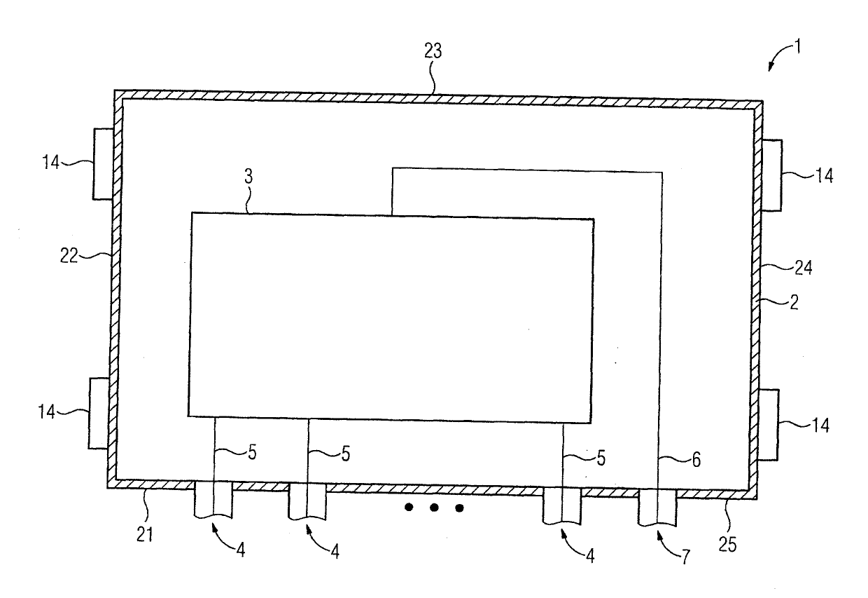

The casing 2 is a covering or an enclosure and may have varied shapes and sizes, for example, the casing 2 may be, but not limited to, a box, i.e., having a cuboidal shape, cylindrical, or hexagonal prism. When the casing 2 has a cuboidal shape, the first side 21 of the casing 2 forms one face of the cuboid. As depicted in the FIG. 1, in a cross-section of the cubiodal casing 2, the first RF ports 4 and the second RF port 7 are all located on the first side 21 that forms exactly one face of the cubiodal casing 2. The other sides 22,23,24 are devoid of the first RF ports 4 and/or the second RF port 7. The casing 2 may be formed of any suitable material used to house RF signal processing devices or RF transmission lines, for example, the casing 2 may be formed of metals, alloys, polymers, or plastics.

In one embodiment of the modified RF power combiner 1, the plurality of the first ports 4 and the second port 7 are embedded in a wall 25 of the casing 2 on the first side 21 of the casing 2. The term ‘embedded’ as used herein means formed within, entrenched, or implanted in. In the modified RF power combiner 1, the wall 25 of the casing 2, along with the plurality of the first ports 4 and the second port 7 embedded in the wall 25, completely or fully covers or encloses a volume (not shown). The matching circuit 3 is positioned in the volume.

In one embodiment of the modified RF power combiner 1, the matching circuit 3, the inner conductors 5 and the single transmission line 6 are arranged within the casing 2 such that the matching circuit 3, the inner conductors 5 and the single transmission line 6 are at fixed positions relative to each other and to the casing 2. This is achieved by fixing or fastening, for example, by using screws, the matching circuit 3, the inner conductors 5 and the single transmission line 6 to the casing 2. Alternatively, the modified RF power combiner 1 may be fabricated in a way that the matching circuit 3, the inner conductors 5 and the single transmission line 6 are fabricated on a surface (not shown) of the casing 2. One example of such fabrication is by printing a circuit of the matching circuit 3, the inner conductors 5 and the single transmission line 6 on the surface of the casing 2.

In the embodiment of the modified RF power combiner 1, where the casing 2 has a cuboidal shape, the cuboidal casing 2 is configured to mount inside a 19-inch rack. Such 19-inch racks or 19-inch cabinets are well known and used prevalently as a standardized frame or an enclosure for mounting multiple equipment modules. The dimensions of the casing 2 are such that the casing 2, and thus the modified RF power combiner 1, is compatible with the 19-inch racks, i.e., the casing 2 and thus the modified RF power combiner 1 is mountable in a 19-inch rack as one of the modules. The casing 2 may additionally include a mount 14 for mounting the modified RF power combiner 1 inside a standard 19-inch rack. In one embodiment of the modified RF power combiner 1, the mount 14 is located on one or more of the other sides 22,23,24 of the casing 2. The other sides 22,23,24 are distinct from the first side 21 of the casing 2.

In an embodiment of the modified RF power combiner 1, the mount 14 is a slide. In this embodiment, the modified RF power combiner 1 is mountable inside a 19-inch rack by slidingly engaging the slide with rails of the 19-inch rack. Generally, a pair of rails is mounted or fixed directly onto the 19-inch rack, and the modified RF power combiner 1 then slides into the 19-inch rack along the rails by contacting the rails of the 19-inch rack with the slide of the casing 2. When placed in a desired position within the 19-inch rack, the casing 2 may then be locked in the desired position by an additional locking mechanism (not shown) to the 19-inch rack. In another embodiment of the modified RF power combiner 1, the mount 14 is a fastener for fixedly mounting the casing 2, and thus the modified RF power combiner 1, inside the 19-inch rack. The fastener may be a bolt and screw mechanism or a clicklock mechanism.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-13. (canceled)

14. A modified Radio Frequency (RF) power combiner comprising:
a plurality of first RF ports;
a single second RF port;
a casing; and
a matching circuit arranged inside the casing;
wherein the plurality of first RF ports and the second RF port are arranged at a first side of the casing.

15. The modified RF power combiner according to claim 14, wherein each first RF port of the plurality of first RF ports is connected via a respective inner conductor to the matching circuit.

16. The modified RF power combiner according to claim 15, wherein each respective inner conductor is arranged inside the casing.

17. The modified RF power combiner according to claim 14, wherein the single second RF port is connected via a single transmission line to the matching circuit.

18. The modified RF power combiner according to claim 5, wherein the single second RF port is connected via a single transmission line to the matching circuit.

19. The modified RF power combiner according to claim 16, wherein the single second RF port is connected via a single transmission line to the matching circuit.

20. The modified RF power combiner according to claim 17, wherein the single transmission line is arranged inside the casing.

21. The modified RF power combiner according to claim 20, wherein the single transmission line forms a 180 degree turn in between the matching circuit and the second RF port.

22. The modified RF power combiner according to claim 14, wherein the casing has a shape; and wherein the first side of the casing forms one face of the cuboid.

23. The modified RF power combiner according to claim 22, wherein the casing is configured to mount inside a 19-inch rack.

24. The modified RF power combiner according to claim 23, wherein the casing comprises a mount for mounting the modified RF power combiner inside a 19-inch rack.

25. The modified RF power combiner according to claim 24, wherein the mounting is a slide; and wherein the modified RF power combiner is mountable inside a 19-inch rack by slidingly engaging the slide means with rails of the 19-inch rack.

26. The modified RF power combiner according to claim 24, wherein the mounting is a fastener for fixedly mounting the modified RF power combiner inside a 19-inch rack.

27. The modified RF power combiner according to claim 14, wherein the plurality of the first ports and the single second port are embedded in a wall of the casing on the first side.

28. The modified RF combiner according to claim 27, wherein the wall of the casing, along with the plurality of the first ports and the second port embedded in the wall, completely encloses a volume; and wherein the matching circuit is positioned in the volume.
